(19) United States
(12) Patent Application Publication
(10) Pub. No.: US 2020/0271561 A1
(43) Pub. Date: Aug. 27, 2020

(54) SYSTEM, APPARATUS AND METHOD FOR MONITOING AIR QUALITY

(71) Applicants: Vladislav I. LAVROVSKY, Vancouver (CA); Kevin R. HART, Port Coquitlam (CA)

(72) Inventors: Vladislav I. LAVROVSKY, Vancouver (CA); Kevin R. HART, Port Coquitlam (CA)

(21) Appl. No.: 16/650,762

(22) PCT Filed: Sep. 26, 2017
(86) PCT No.: PCT/CA2018/000182

§ 371 Date: Mar. 25, 2020

Related U.S. Application Data
(60) Provisional application No. 62/563,507, filed on Sep. 26, 2017.

(51) Int. Cl. G01N 15/02; B01D 35/143

(52) U.S. Cl. CPC G01N 15/0205; G01N 2015/0046; B01D 35/1435

(57) ABSTRACT

An air quality monitoring device and system for monitoring multiple streams of air. The present invention includes structural components to separate and/or obtain multiple streams of air and a single optical particle counting (“OPC”) system. The structural components may include a housing for the OPC system and a conduit. The conduit may be a flexible tube or fixed structural channel. The OPC system may include multiple optical detectors and an optical emitter. The optical emitter may be a laser.

### FIELD OF INVENTION

This invention relates generally to the measurement of air quality, and more specifically to a system and apparatus to measure particulate matter entrained in a fluid that passes through a filter.

### BACKGROUND OF THE INVENTION

Airborne particulate matter is among the deadliest forms of air pollution. The risk of lung cancer is greatly increased by the concentration of particulate matter below PM10. Asthma, cardiovascular disease, respiratory diseases and birth defects have also been associated with increases in airborne particulate matter concentration. In addition, these conditions are a detriment to the economy, resulting in thousands of workers on sick leave per day and billions of dollars of strain on health care systems around the world. Environmental researchers often do not have the budget to purchase multiple devices to develop data maps in order to monitor these adverse environmental conditions.

Airborne particulate matter may be measured with a light scattering aerosol spectrometer, or LSAS. These sensors count and size particles individually, respond quickly to changing environmental conditions, and can continuously monitor conditions for months without user intervention. Typically a LSAS works by drawing a sample of air through a beam of light. The beam of light is scattered due to the particles entrained in the sample of air. Optical counting systems direct the scattered light to a photodiode, which converts the collected light into current that is then amplified into an analog voltage signal. The voltage signal is typically a pulse, where the pulse width and amplitude are proportional to the light intensity and particle diameter. The particle size, incident light, and other physical characteristics may be determined from this pulse. The concentration of particles entrained in the sample of air may also be determined by analyzing the pulses over time.

These particulates may be removed by passing the airflow through a filter. As the airflow passes through the filter, many particulates in the airflow are trapped within the filter and removed. However, over time the filter becomes contaminated and clogged with the trapped particulates and requires replacement. Accordingly, there is a need for a low cost, effective method of monitoring and tracking environmental conditions, along with a need to determine when a filter is in need of replacement.

### SUMMARY OF THE INVENTION

The present invention generally provides a system, apparatus, and method for detecting and measuring particles entrained in fluid streams, and more specifically, for detecting and measuring particles entrained in multiple air streams, and comparing characteristics or properties of the particles in the multiple fluid streams, and filter life based on these properties.

The apparatus may have structural components to separate and/or obtain multiple streams of air and a particle detection unit for detecting particulate in the air streams. The system and apparatus may measure air quality in multiple fluid streams simultaneously in a single apparatus. For example, one apparatus may measure air quality in two fluid streams, such as at un-filtered (i.e. dirty or contaminated airflow) points and post-filter (i.e. clean airflow) points simultaneously. The un-filtered airflow point may be pre-filter (i.e. upstream from the filter location within a fluid stream) or in an entirely different fluid stream from the filter. Both pre-filter and post-filter air flow is directed through the housing where the OPC analyzes the level of particulates in both the contaminated airflow and clean airflow.

In an embodiment, the system has a wireless communication system for transferring data between the apparatus and other air quality devices in a local network, such as smartphones, computers and internet access points for data processing, data visualization and communication. The system may have a cloud-based or direct interface to any other local peripherals such as external calibration references or auxiliary sensors. The system may also have sensors for measuring properties (e.g. temperature of ambient, pressure, particulate quantity/type etc.) of the environment, a microcontroller unit configured to receive and process signals produced by the sensors, and a transmitter for transmitting the data to a cloud system via an access point, where it is ingested, processed and stored.

Upon reading the description herein, various embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1 is a top perspective view of an embodiment of the apparatus of the present invention.

FIG. 2 is a bottom perspective view of an embodiment of the apparatus of FIG. 1.

FIG. 3 is a front view of an embodiment of the apparatus of FIG. 1.

FIG. 4 is a rear view of an embodiment of the apparatus of FIG. 1.

FIG. 5 is a top view of an embodiment of the apparatus of FIG. 1.

FIG. 6 is a bottom view of an embodiment of the apparatus of FIG. 1.

FIG. 7 is a side view of an embodiment of the apparatus of FIG. 1.

FIG. 8 is a side view of an embodiment of the apparatus of FIG. 1.

FIG. 9 is a top perspective view of an embodiment of the apparatus of FIG. 1 with a mounting plate according to an embodiment.

FIG. 10 is a perspective view of an embodiment of the system of the present invention.

FIG. 11 is a side view of an embodiment of the system of FIG. 10.

FIG. 12 is a top view of an embodiment of the system of FIG. 10.

FIG. 13 is a front view of an embodiment of the system of FIG. 10.

FIG. 14 is a rear view of an embodiment of the system of FIG. 10.

FIG. 15 is a schematic drawing of an additional embodiment of the apparatus of FIG. 1.

FIG. 16 is a schematic drawing of an additional embodiment of the apparatus of FIG. 1.

FIG. 17 is a schematic drawing of an additional embodiment of the apparatus of FIG. 1.

FIG. 18 is a schematic drawing of an additional embodiment of the apparatus of FIG. 10.

FIG. 19 is a flowchart showing an embodiment of a method of monitoring airflow using embodiments of the system of FIG. 10 and the apparatus of FIGS. 1-9.

FIG. 20 is a flowchart showing an embodiment of a method of monitoring airflow using embodiments of the system of FIG. 10.

FIG. 21 is a flowchart showing an embodiment of a method of monitoring airflow using embodiments of the system of FIG. 10.

### DETAILED DESCRIPTION OF THE INVENTION

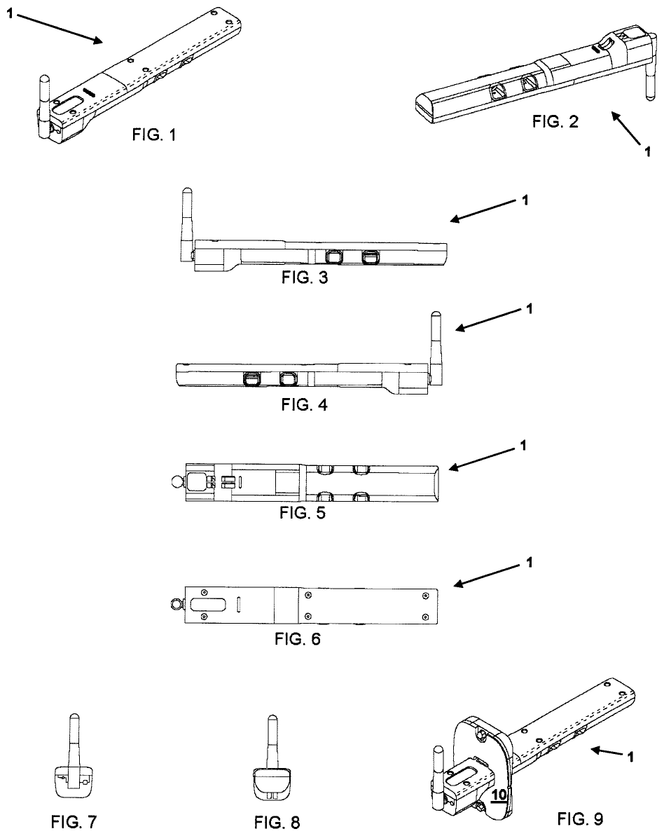

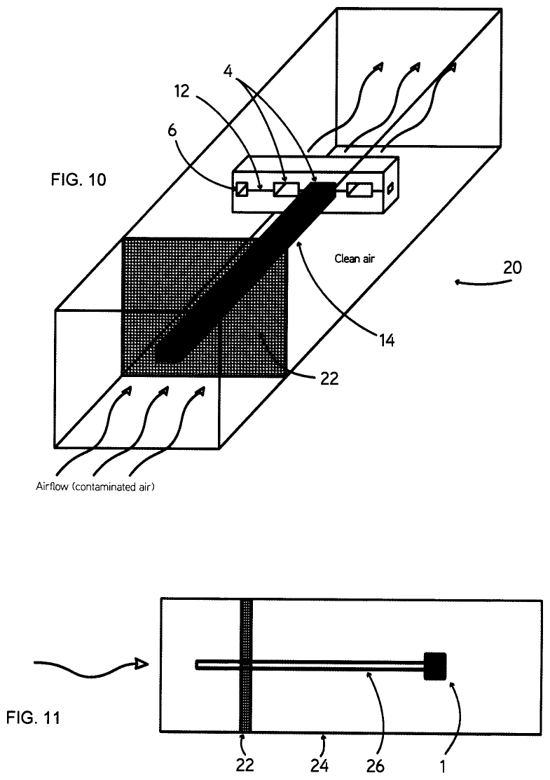

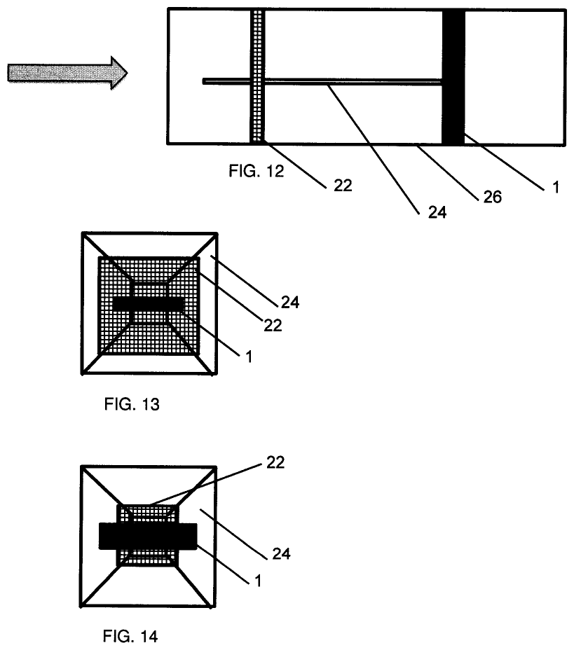

FIGS. 1-9 show an embodiment of the apparatus. FIGS. 10-14 show an embodiment of the system containing the apparatus. The particle detection system and apparatus 1 detect and measure particles entrained in a fluid flowing within a fluid stream and traverse a filter 22. The arrow refers to the airflow direction. In an embodiment, the apparatus 1 has a housing 2 with a top side, a bottom side, an upstream side, a downstream side, a first distal end, a second distal end, and an elongate shape, apertures 4 extending between the upstream and downstream sides of the housing 2. The apparatus also has sensors (not shown) within the housing, a circuit board with circuits for interfacing with all electronic components and the sensors, and a particle detection unit disposed within the housing.

In an embodiment of the system, the apparatus 1 is located within the fluid stream downstream from an air filter 22. The filtered airflow may be inside an air duct 24, air purifier, air hander, multi-stage air cleaner/air handler unit, media air cleaner, air conditioner, split type unit, or any similar device that has airflow stream(s) and a filter.

The housing of the apparatus 1 may include apertures 4 that allow air to pass through a sensing region on the apparatus 1. Each aperture has an inlet and an outlet. FIG. 10 illustrates three apertures 4. Two are configured to receive filtered “clean” air and one is configured to receive unfiltered “dirty” air from a point upstream from the filter 22. Each aperture 4 may have an inlet and outlet. In an embodiment, at least one apertures 4 is open to the post-filter, clean airflow (i.e. the clean aperture).

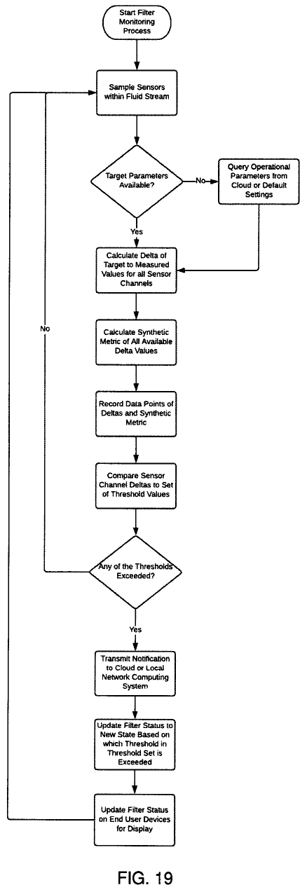

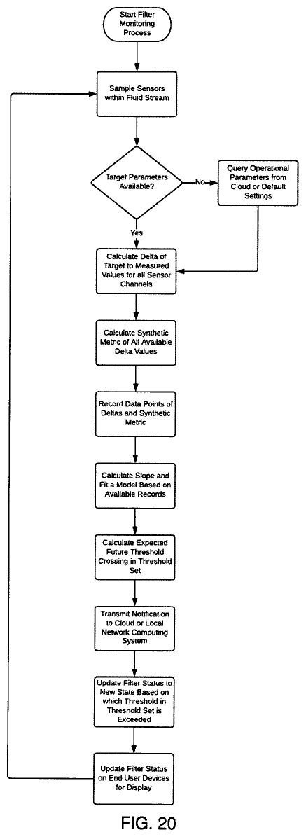

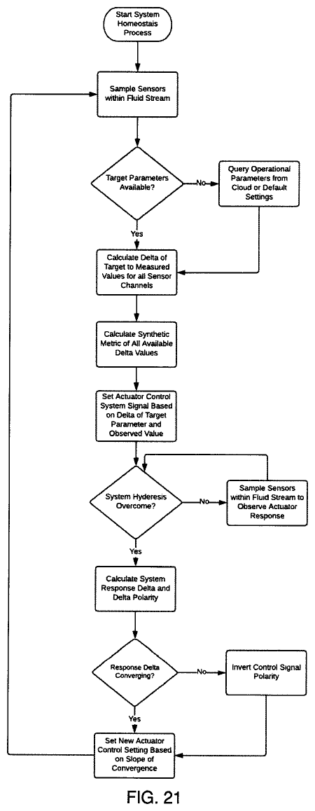

A portion of the contaminated airflow is diverted away from the filter through the conduit 14. The conduit 14 collects a sample of fluid to be analyzed by the system. The conduit 14 has inlets and an outlet and is connected to the apertures 4. In an embodiment, the conduit is fork shaped, has smaller conduits 18, 19 extending out of it, and has a valve 16 (FIG. 19) for selecting a fluid stream flowing through one of the smaller conduits. In an embodiment, the system has a manifold. The conduit 14 may include a flexible tube or fixed structural channel (or a combination of both), an inlet, and an outlet. The outlet is in communication with the inlet of one of the 4 (i.e. a “contaminated” aperture). The conduit 14 extends from the housing beyond the control filter but not past the airflow filter such that its inlet end is located within the pre-filter air flow. This allows for pre-filtered (i.e. contaminated) airflow to enter the conduit's inlet, travel through the conduit 14, and enter the contaminated aperture. In other embodiments, the conduit may be located anywhere along the length of the apparatus and anywhere along the airflow (e.g. in the middle of the channel, on the side, etc.). Further, a flexible conduit may bend, exit the airflow passage, and pass along the outside thereof. Further, the conduit may use nozzles and/or diffusers to increase or decrease air speed respectively.

In an embodiment, the apparatus may include structural components to separate and/or obtain multiple streams of air, a single particle counting system, such as an Optical Particle Counter (OPC), and a housing for the OPC.

The particle detection unit has an electromagnetic radiation emitter 6 and a particle detector 8. Each emitter and detector combination (or multiple combinations) form a particle detection unit. In an embodiment, the unit straddles at least one aperture.

In an embodiment, the particle detection unit has an optical electromagnetic radiation emitter 6 and an optical particle detector 8. An optical path 12 traverses an aperture 4 and extends between the optical emitter 6 and the optical particle detector 8. FIG. 10 shows an embodiment with one optical emitter 6 and one optical path 12 intersecting with at least two apertures 4. The optical path 12 intersects with the clean aperture (i.e. a “clean” sensing region) and with the contaminated aperture (i.e. a “contaminated” or “dirty” sensing region). Other embodiments may include the intersection of the optical path with more than two apertures, and that the order upon which the apertures intersect the optical path may be altered. The apparatus may have lens for refocusing beam divergence and at least one flow sensor in at least one aperture. The detector may be a photodiode, a flow sensor, or a combination thereof.

The apparatus may include multiple optical detectors and an optical emitter. The optical emitter may be a laser diode with a built-in or separate driving circuit. The light emitted therefrom travels through the optical path. The optical emitter may be used as a light source to be scattered by entrained particles in the sensing regions as they move through the apertures. Other optical components may be used to shape and direct the optical emitter through the sensing regions. Other embodiments may include more than one optical emitter, more than one optical detector, or a combination thereof. The emitter may be in a metallic enclosure for electrostatic and thermal protection.

The optical emitter may contain a monitor diode for automatic power control (APC). APC is required to maintain stability of the laser over time and over temperature which is critical to the repeatability of particulate measurements. In an embodiment, the optical emitter may have an external monitor diode. The external monitor diode has the same function as an internal monitor diode as an input into the APC circuit. The use of an external monitor diode allows the use of lasers that do not have an integrated monitor diode.

In an embodiment the optical emitter is a vertical cavity surface emitting laser (VCSEL). The VC-SEL laser has a lower beam divergence, resulting in a superior beam shape at an equivalent spot size relative to other solid state lasers. The uniformity of the beam is greater in the embodiment utilizing the VCSEL, which reduces the amplitude range for particulates of any singular optical diameter. Thus, the sizing resolution of the device is improved over devices using an edge emitting laser. The VCSEL laser is more efficient at an equivalent power to that of an edge emitting laser, resulting in lower power consumption and reduced thermal load.

In this embodiment, the optical detectors may be photodiodes, airflow sensors or a combination thereof. The OPC may also include a microcontroller unit (MCU), digital signal processor (DSP), integrated circuit, or control electronics configured to receive and process signals produced by environmental sensors, and a transceiver for communicating with a proximal network, for data acquisition and analysis.

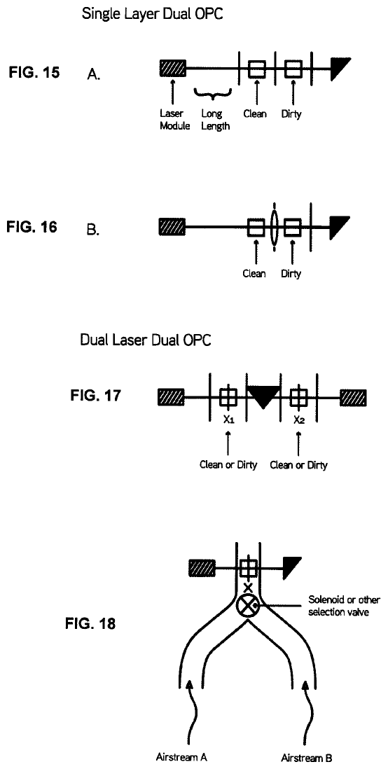

In an embodiment, a clean airflow optical detector is placed within the clean sensing region and a contaminated airflow optical detector is placed within the contaminated sensing region in the apparatus's housing. As illustrated in FIGS. 10 and 15-19, light from the optical emitter 6, traveling through the optical path 12, intersects with the clean airflow and contaminated airflow as the respective airflows pass through their respective apertures 4. Airflow data obtained from the two sensing regions may be analyzed and compared. Based on the analyzed data, various actions may be taken. For example, a clean air sample has 1000 particles while a contaminated air sample has 100 particles. The difference, or delta, is 900 particles. As the difference demonstrates the airflow filter is removing an acceptable amount of particles, the filter does not need to be changed. However, if a clean air sample has 1000 particles while a contaminated air sample has 600 particles resulting in a delta of 400, the result is the airflow filter is not removing sufficient particles from the airflow. The action would be to replace the airflow filter. In some embodiments, alerts or notices may be provided. Some forms of these alerts and notices may be, but not limited to, audio, visual, i.e. illuminated lights, on a display or electronic notices.

In an embodiment, the device may include a control filter. The control filter may be located upstream from the apparatus housing and downstream of the airflow's filter. The pre-filtered airflow would be the airflow that passes through the airflow filter but not through the control air filter. The post-filter airflow would be the airflow that passes through both the airflow filter and control filter. Alternatively, the apparatus may not include a control filter. In this embodiment, the conduit 14 extends beyond the airflow filter. The pre-filtered (i.e. contaminated) and post-filtered (i.e. decontaminated, filtered) airflow would be the airflow located upstream and downstream from the airflow filter, respectively.

Other embodiments may have significantly different dimensions and geometry. Additional components may be used inside the enclosure other than the major components to aid in the function of the device. In an embodiment, the last detection point may be a point located downstream (in terms of direction of air stream, if they are in the same air stream), specifically at the most downstream point that may change the composition of the air. In an embodiment, the system has multiple detectors per sampling path/aperture in order to improve sensitivity or ability to correctly determine the size of the particle.

Any part of the structural components may have an engineered surface finish and/or selective metal deposition/plating for aesthetic and/or optical reasons. A metal finish may be used to create mirrors for the optical system. The structural components may be curved to create mirrors with different optical behaviors. Any part of the structural components may contain features for directing the airflow for the sensor. Gaskets, flexible plastic, epoxy, tape or other materials may be used to improve the function of these features. Features may be added to any part of the structural components to reduce or increase intake or outlet air flow velocities. Any part of the structural components may be coated or covered with a light absorbing paint, finish, tape, and/or other material.

In an embodiment the housing is composed of plastic, the material of the plastic is dimensionally stable over temperature to prevent misalignment of the optical components. The housing may be composed of a single material or a composite of multiple materials, which may be engineering thermoplastics such as PEEK, PPS, PET or other dimensionally stable material. In an embodiment the housing is composed of a thermoplastic that is tough and resistant to impacts such as nylon, UHMW, or other plastics. This embodiment is for applications where physical impacts and rough handling are common.

The housing may be sealed or painted to prevent or slow the rate of water absorption with the atmosphere. In this way, the stability of the housing is maintained over long periods of time.

In an embodiment, airflow data may be wirelessly transferred to a remote location for storage and further processing and/or analysis. The system may generate and transmit alerts or notifications related to filter replacement or air quality events. For example, the system may alert a user as to when the filter has reached a predetermined contaminated threshold and requires replacement.

Referring to FIG. 16, in an embodiment, the apparatus includes a lens or window between the clean sensing region and the contaminated sending region. The lens may be used when the optical emitter produces a short length beam that diverges sufficiently between the two sensing regions to require refocusing of the beam. Further, in those embodiments that include more than two sensing regions, multiple refocusing lenses may be located between multiple sensing regions. In an embodiment, the lens may be located outside of the emitter. Referring to FIG. 17, in an embodiment, an optical emitter may include more than one a light source for each sensing region. In this embodiment, both clean air and contaminated air may pass through each sensing region.

Referring to FIG. 18, in an embodiment, a single sensing region may allow for different types of airflow to pass there through. In the embodiment, a valve, such as a solenoid, may be located upstream of the sensing region and may toggle between a clean airflow and a contaminated airflow. This allows for both clean airflow and contaminated airflow to pass through the same sensing region. In additional embodiments, a valve may manage more than two airflow streams for passage through one or more sensing regions.

In an embodiment, an airflow actuator (e.g. fan or pump) may be utilized to either push or pull air through the apertures. The actuator may be located upstream or downstream from the sensing region of the apparatus. The actuator may be secured to the housing or could be independent of the housing. The aperture shape may be cylindrical, tapered, hourglass, or nozzle shaped, or a combination thereof. The aperture may have a bypass. The apparatus may also have a mounting plate 10 (FIG. 9) for mounting the housing to a duct.

In an embodiment, the housing has two separate components linked with a wired interconnect. The second component is attached via the interconnect, allowing it to be positioned on surfaces distant from the first component. The second housing component is not in the fluid stream and thus can be any size to accommodate additional electronics and wireless transceivers. The second component may have a plurality of antennas for beam forming of a single signal or for operating on multiple RF bands or protocols concurrently.

In an embodiment, the system has a microcontroller or other integrated circuit configured to receive and process signals produced by environmental sensors, and a transceiver (hardwire or wireless) for communicating with a proximal network. The hardwire transceiver may utilize RS-422, RS-432, RS-485, USB, Ethernet, POE or other standards or protocols. The apparatus may have multiple wireless transceivers of the same or different types. The wireless transceiver may utilize Bluetooth, Zigby, WiFi, Lora, SigFox, NB-IOT, CAT-M1 or other standards or protocols. The apparatus may simultaneously utilize multiple wireless protocols or both wired and wireless protocols.

In an embodiment, the system may have a user interface which may be one or more status LEDs, an LCD or OLED display or other HID device. The apparatus may have one or more buttons used to configure or manage the device. These may be mechanical in nature such as a push button or other type such as inductive, capacitive or optical buttons. The interface may also be implemented as a gesture sensor utilizing capacitive arrays or optical gesture sensors.

In an embodiment, the system counts the total number of particles that pass through a filter. The system measures and records the number of particles accumulating in the filter by calculating the total detection events and extrapolating that count to the total cross-sectional area of the duct. The system detects particulate events and records the flow velocity for each such capture of data. The system contains metadata on the duct dimensions and filter type and filter performance. The capture efficiency of the filter is based on the filter classification or grade. The system determines the loading rate based on the flow rate, the particle load, the capture efficiency of the filter. The system continuously monitors the fluid stream parameters across the sensor and thus across the filter. When the filter meets or exceeds a predetermined rate of accumulation, the system sends a notification (e.g. message, alarm, etc.) to a monitor indicating that the filter status has changed (e.g. needs replacement). The system may then notify a user of the change in status. They may be many different levels of notification allowing the user to gauge the current lifespan remaining of the filter.

In an embodiment, the system has a flow sensor. The flow sensor continuously measures the flow velocity (and changes to the flow velocity) and mass displacement across the flow sensor. When particles accumulate within the filter, the flow velocity and mass displacement also may change. The loss of velocity or mass displacement indicate that particulate has accumulated within the filter (i.e. filter gets dirty and needs replacement).

In an embodiment, the system may have a fixed or variable fluid flow settings (e.g. variable flow speeds). Regardless of the setting, the system measures the cumulative loss of fluid flow and mass displacement over time (rather than measuring only instantaneous changes). The system measures and tracks the flow characteristics over time, creates flow trend data based on these characteristics, and ultimately may predict when the filter needs replacement based on these observed trends. The system may track an unlimited number of set points up to the resolution of the flow sensor. In this way, drift of the flow velocity may be measured across changes in the system speed set point. The system observes the slope of the loss of flow or displacement in the fluid stream over time, the length of which is a function of the mechanical system and the filter specifications. The observed slope is extrapolated to find the time in the future when the filter has been loaded sufficiently that it has a negative impact on the performance of the fluid handling system and replacement is warranted. Using metadata acquired at the time of installation of the filter this determination may be made automatically by utilization of the filter model. Alternatively, if no model is available, then the system can use a metric based on loss of performance relative to when the filter was first installed.

In an embodiment, the system has an actuator that forces the fluid to move through the system. The system modulates the fluid flow through the system by controlling actuator based on the filter loading data or the flow trend data. For example, the system instructs the actuator to increase or decrease its performance based on the filter loading data or the flow trend data.

In an embodiment, the actuator is a fluid flow actuator, such as an HVAC blower with a variable speed drive. The system has a blower controller that controls the HVAC blower (e.g. by sending a control signal to the blower). The blower controller adjusts parameters in the PID loop of the blower. The system may adjust the blower's RPM or speed based on the filter loading data or the flow trend data.

In an embodiment, the system may modulate the RPM or speed of the blower by changing the duty cycle of the HVAC system. This ensures that the total displacement and thus number of room air changes is held constant as the filter ages or is loaded. The duty cycle of the system may be increased all the way to 100% if required. As the duty cycle increases, the status of the system may be escalated and this is used to trigger user notifications to replace the filer.

FIG. 19 is a flowchart showing a method of monitoring airflow using embodiments of the system of FIG. 10 and the apparatus of FIGS. 1-9. In an embodiment, the system monitors a filter's status (e.g. clean v. dirty) based on properties of a fluid in a fluid stream by measuring properties (e.g. flow velocity associated with the fluid stream, mass displacement of the fluid stream, particulate load associated with the fluid stream, or a combination thereof) of the fluid stream at a point in time (“t1”), determining a filter operational efficiency value based on these measured properties at this time, repeating these steps above at subsequent points in time, for example (second, third, and fourth points in time, t2, t3, and t4, respectively) until the filter operational efficiency reaches a predetermined threshold. For example, the threshold may be an undesirable or low efficiency rating when the filter is dirty and needs replacement. After the efficiency reaches this threshold, the system transmits a notification to a storage device, a cloud computing system, or a display within the system or outside of but associated with the system. For example, the notification may indicate that the filter is dirty and needs replacement. Throughout this process, the system continually monitors the filter efficiency rating and observes how it changes over time from when a new filter is initially installed. For example, the system observes a new, clean filter over time, observes it getting dirty, and issues a notification or alert when the filter is so dirty that it needs replacement. The system continually refreshes the filter status based on the threshold notification so that the efficiency ratings are up to date and notifications of a filter's status change (e.g. from clean to dirty enough to require replacement) are issued immediately. In an embodiment, the system displays the refreshed filter status on a display to initiate a filter replacement process (manual or automated).

The system stores the filter operational efficiency data over time and identifies trends based on it. It then predicts future filter operational efficiency patterns based on the actual, observed filter operational efficiency patterns and data trends.

In an embodiment, the system has a flow controller for maintaining the fluid velocity constant over time by adjusting the fluid velocity and or pressure within the fluid stream based on the measured fluid stream properties (e.g. flow velocity associated with the fluid stream, mass displacement of the fluid stream, particulate load associated with the fluid stream, or a combination thereof). The system generates a control signal based on these properties at t1. It then sends the control signal to a fluid flow actuator in the system. Next, it measures the properties of the fluid stream at a subsequent time tn, where “n” equals any point(s) in time subsequent to t1. The system then compares the measured properties to a desired threshold. For example, the system compares t1 to the threshold, and tn (e.g. where tn equals 1 hour after t1) to the threshold form two deltas. The deltas represent the differences between the measured properties at a given point in time and the threshold. The system then calculates difference between the two deltas to form a major delta. The major delta may be positive or negative. The system then determines whether the deltas are converging or diverging based on the major delta. The system inverts the control signal polarity if the deltas are diverging. The system then compares the major delta to a desired set-point and updates the control signal based on the comparison between the major delta and the desired set-point.

In an embodiment, the system generates a differential signal from two or more channels of data to quantify filter operational efficiency.

In an embodiment, the system measures the efficiency of the filter as follows. It measures air particulate properties from at least two fluid streams, compares these properties, and calculates the operational efficiency E of the filter based on these properties. For example, in a system with two fluid streams, when both fluid streams are contain the same air (e.g. clean air), E=100%. When one stream has dirty air and one has clean air, E is less than 100%. The system generates a differential signal when E<100%.

| Time of Data | | | E = [Fluid Stream 1/ |
|---|---|---|---|
| Collection (t) | Fluid Stream 1 | Fluid Stream 2 | Fluid Stream 2] × 100 |
| t1 | Clean Air (1) | Clean Air (1) | 100% |
| t2 | Clean Air (1) | Minimal Particulate | 99.00% |
| | | (1.01) | |
| t3 | Clean Air (1) | Medium Particulate | 95.24% |
| | | (1.05) | |
| tn | Clean Air (1) | Heavy Particulate | 90.90% |
| | | (1.100) | |

By measuring E in pre and post filter fluid streams over time (e.g. at t1, t2, t3 . . . tn) the exact capture filter efficiency may be determined. This filter efficiency is tracked to establish the trend in loading. In an embodiment, the system may observe multiple different phases of filter life by looking at the change in E over time. The differential measurement by the system can measure all of these transitions in the filter performance by measurement across the filter medium. The measurement from both channels of data is continuously compared to observe changes in the capture efficiency. The system may use particulate sizing and binning of particles based on their optical diameter. In this way the system can separately measure the capture efficiency across particles of different sizes.

Thus the system can determine that the filter state across each range of particles and quantify the performance for each range or band. In this way the system can detect when large particles are captured by fine particles are not and vice versa. This information is transmitted to the cloud and to the user to drive filter replacement schedules or installation.

In an embodiment, the data may be transmitted with a hardline protocol or stored onboard in memory for future retrieval. The embodiment may use RS-232, RS-485, Modbus, Ethernet or other interface to the wired network. Further, other embodiments may involve part or all of this embodiment packaged inside OEM hardware; such an embodiment may provide an electronic (SPI, I2C, Serial or other) or wireless (Bluetooth Low Energy (BLE), Wi-Fi, Xigbee, or other) interface to the OEM hardware.

In an embodiment, the system and apparatus may utilize mechanical actuation to select between one or more sets of streams of fluid. The streams may be directed by way of manifold or discrete tubing and be multiplexed through the action of electric, pneumatic or hydraulic valves or solenoids. In other embodiments pumps may be used to select which stream is delivered to the device. The fluid streams may be delivered by tubing, and in some embodiments this tubing may be of an anti-static or conductive material or processed to ensure that the inner surfaces are conductive by the application of conductive additives such as silver, metal oxides, carbon black, graphite, carbon nanotubes or other conductive materials. The tubing may be routed without sharp bends or other small radiuses to minimize losses of the particles entrained in the fluid.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

What is claimed:

1. An particle detection apparatus for detecting and measuring particles entrained in a fluid flowing in a flow direction within a fluid stream, the apparatus comprising:
a housing comprising a top side, a bottom side, an upstream side, a downstream side, a first distal end, a second distal end, and an elongate shape;
a plurality of apertures in the housing extending between the upstream and downstream sides of the housing, the plurality of apertures comprising a plurality of inlets and a plurality of outlets;
a plurality of sensors disposed within the housing; and
a circuit board disposed within the housing, the circuit board comprising circuits for interfacing with all electronic components and the plurality of sensors.

2. The apparatus of claim 1, further comprising:
an electromagnetic radiation emitter disposed within the housing; and
a particle detector disposed within the housing.

3. The apparatus of claim 1, further comprising a mounting plate for mounting the housing to a duct.

4. The apparatus of claim 1, further comprising a particle detection unit comprising an emitter and a particle detector.

5. The apparatus of claim 4, wherein the particle detection unit straddles at least one of the apertures of the plurality of apertures.

6. The apparatus of claim 1, further comprising a particle detection unit comprising a plurality of pairs of emitters and particle detectors.

7. The apparatus of claim 2, wherein
the emitter comprises an optical emitter, and
the particle detector comprises an optical particle detector.

8. The apparatus of claim 7, further comprising an optical path traversing the aperture and extending between the emitter and the particle detector.

9. The apparatus of claim 7, further comprising a lens for refocusing beam divergence.

10. The apparatus of claim 1, wherein at least one sensor of the plurality of sensors comprises at least one flow sensor disposed in at least one of the apertures.

11. The apparatus of claim 1, wherein the detector comprises a photodiode, a flow sensor, or a combination thereof.

12. The apparatus of claim 1, wherein at least one aperture of the plurality of apertures comprises a cylindrical shape, a tapered shape, an hourglass shape, a nozzle shape, or a combination thereof.

13. The apparatus of claim 1, wherein at least one aperture of the plurality of apertures comprises a bypass.

14. A system for use with a filter and fluid flowing in a flow direction within a fluid stream for detecting and measuring particles entrained in a fluid that traverses the filter, the system comprising:
the apparatus of claim 1, wherein the apparatus is disposed within the fluid stream at a downstream end of the filter, and
a conduit for collecting a sample of fluid, the conduit comprising a plurality of inlets, and an outlet,
wherein the conduit is connected to the plurality of apertures.

15. The system of claim 14, wherein the conduit comprises
a forked shaped conduit comprising a plurality of smaller conduits, and
a valve for selecting a fluid stream flowing through one of the smaller conduits of the plurality of smaller conduits.

16. The system of claim 14, further comprising a manifold.

17. The system of claim 14, wherein the outlet of the conduit is connected to one of the apertures of the plurality of apertures.

18. The system of claim 14, wherein the conduit comprises a plurality of conduits, and at least one conduit of the plurality of conduits is connected to at least one of the apertures of the plurality of apertures.

19. The system of claim 14, wherein the inlet of the conduit is disposed within a volume of unfiltered air.

20. The system of claim 14, wherein the conduit extends through the filter.

21. The system of claim 14, wherein the conduit comprises an external conduit for bringing external fluid streams into the system.

22. The system of claim 14, further comprising a filter.

23. The system of claim 14, further comprising
a microcontroller or other integrated circuit configured to receive and process signals produced by environmental sensors; and
a transceiver for communicating with a proximal network.

24. A method of monitoring filter status based on properties of a fluid in a fluid stream, the method comprising:
providing
a fluid stream,
a sensor disposed within the fluid stream,
measuring properties of the fluid stream at a time (t1);
determining a t1 filter operational efficiency based on the measured properties at t1;
repeating the steps above at subsequent points in time (t2, t3 . . . tn) until the filter operational efficiency reaches a predetermined threshold;
transmitting a threshold notification to a storage device, a cloud computing system, or a display;
refreshing the filter status based on the threshold notification; and
displaying the refreshed filter status on a display.

25. The method of claim 24, further comprising
determining a tn filter operational efficiency based on the measured properties at tn;
determining a filter operational efficiency trend based on the filter operational efficiency at t1 and the filter operational efficiency at tn;
storing the filter operational efficiency trend;
predicting future filter operational efficiency based on the filter operational efficiency trend;
updating the filter status based on the predicted future filter operational efficiency; and
displaying the updated filter status on a display.

26. The method of claim 24, wherein the properties comprise
flow velocity associated with the fluid stream,
mass displacement of the fluid stream,
particulate load associated with the fluid stream, or
a combination thereof.

27. The method of claim 24, further comprising a flow controller for maintaining the fluid velocity constant between t1 and tn by adjusting the fluid velocity and or pressure within the fluid stream based on the properties.
generating a control signal based on the properties at t1;
sending the control signal to a fluid flow actuator in the system;
measuring properties of the fluid stream at a time (tn);
comparing the t1 properties to a desired threshold to form a t1 delta;
comparing the tn properties to a desired threshold to form a tn delta;
calculating difference between tn delta and t1 delta to form a major delta;
calculating whether the deltas are converging or diverging and inverting the control signal polarity if the deltas are diverging;
comparing the major delta to a desired set-point; and
updating the control signal based on the comparison between the major delta and the desired set-point;

28. The method of claim 24, further comprising generating a differential signal from two or more channels of data to quantify filter operational efficiency.
